(19) United States
(12) Patent Application Publication
(10) Pub. No.: US 2025/0381623 A1
(43) Pub. Date: Dec. 18, 2025

(54) LASER CUTTING APPARATUS AND LASER CUTTING METHOD

(71) Applicant: NISSAN TANAKA CORPORATION, Iruma-gun, Saitama (JP)

(72) Inventors: Shota TAKAHASHI, Iruma-gun (JP); Norihiro KUROSAWA, Iruma-gun (JP); Daisuke IHARA, Iruma-gun (JP); Naoki KOBAYASHI, Iruma-gun (JP)

(21) Appl. No.: 18/878,380

(22) PCT Filed: Jul. 4, 2023
(86) PCT No.: PCT/JP2023/024791

§ 371 Date: Dec. 23, 2024

(30) Foreign Application Priority Data
Jul. 11, 2022 (JP) 2022-111342

(51) Int. Cl. B23K 26/38; B23K 26/06; B23K 26/14

(52) U.S. Cl. CPC B23K 26/38; B23K 26/0648; B23K 26/1462

(57) ABSTRACT

Disclosed is a laser cutting apparatus for laser cutting a workpiece including: a laser irradiation device having a laser beam irradiation unit for emitting a laser; a laser processing head disposed at a side of the workpiece of the laser beam irradiation unit; and a control unit, wherein the laser processing head has a nozzle part at a tip end on a side of the workpiece, and wherein the control unit performs control on at least one of the laser irradiation device and the laser processing head such that the laser is emitted onto the workpiece while interfering with an inner circumferential surface of the nozzle part.

### TECHNICAL FIELD

The present invention relates to a laser cutting apparatus and a laser cutting method. Priority is claimed on Japanese Patent Application No. 2022-111342, filed Jul. 11, 2022, the content of which is incorporated herein by reference.

### BACKGROUND ART

In the related art, a laser cutting apparatus that irradiates a workpiece with a laser to cut the workpiece is known. In general, for example, as in a laser nozzle and a laser processing head described in Patent Document 1, a laser is passed through a condensing lens, and thus a focal point of the laser is controlled. Then, the laser of which the focal point has been controlled is passed through an internal passage of the laser nozzle provided at a tip end of the laser processing head, and a workpiece is irradiated with the laser.

### CITATION LIST

### Patent Document

Patent Document 1: Japanese Unexamined Patent Application, First Publication No. 2022-36420

### SUMMARY OF INVENTION

### Technical Problem

A laser cutting apparatus melts a workpiece such as a metal workpiece with a laser and then blows away the molten metal with an assist gas that flows coaxially with the laser. These steps are performed continuously or intermittently in a cutting direction of the workpiece to cut the workpiece. At this time, scratches are formed in a thickness direction of the workpiece (an irradiation direction of the laser), and a cut surface becomes rough. In the laser cutting apparatus, a cut surface with less roughness is required from the viewpoint of appearance after processing or the like.

In view of the above circumstances, an object of the present invention is to provide a laser cutting apparatus and a laser cutting method by which the roughness of a cut surface of a workpiece is reduced.

### Solution to Problem

According to a first aspect of the present disclosure, there is provided a laser cutting apparatus for laser cutting a workpiece including: a laser irradiation device having a laser beam irradiation unit for emitting a laser; a laser processing head disposed at a side of the workpiece of the laser beam irradiation unit; and a control unit, wherein the laser processing head has a nozzle part at a tip end on a side of the workpiece, and wherein the control unit performs control on at least one of the laser irradiation device and the laser processing head such that the laser is emitted onto the workpiece while interfering with an inner circumferential surface of the nozzle part.

According to a second aspect of the present disclosure, in the laser cutting apparatus according to the first aspect, the laser irradiation device includes a condensing lens, and the control unit controls a position of the condensing lens such that the laser is emitted onto the workpiece while interfering with the inner circumferential surface of the nozzle part.

According to a third aspect of the present disclosure, in the laser cutting apparatus according to the first aspect, the control unit controls a position of the nozzle part such that the laser is emitted onto the workpiece while interfering with the inner circumferential surface of the nozzle part.

According to a fourth aspect of the present disclosure, in the laser cutting apparatus according to any one of the first to third aspects, the nozzle part includes a cooling portion that causes a liquid to flow into the nozzle part.

According to a fifth aspect of the present disclosure, in the laser cutting apparatus according to any one of the first to third aspects, the laser processing head has a cooling adapter, and the cooling adapter includes a cooling portion that causes a liquid to flow into the vicinity of the nozzle part.

According to a sixth aspect of the present disclosure, there is provided a laser cutting method for laser cutting a workpiece including emitting a laser onto the workpiece while causing the laser to interfere with an inner circumferential surface of a nozzle part.

According to a seventh aspect of the present disclosure, the laser cutting method according to the sixth aspect further includes introducing a liquid into a cooling portion to cool the nozzle part.

### Advantageous Effects of Invention

According to the laser cutting apparatus and the laser cutting method of the present disclosure, it is possible to provide a laser cutting apparatus and a laser cutting method by which the roughness of a cut surface of a workpiece is reduced.

### BRIEF DESCRIPTION OF DRAWINGS

FIG. 1 A conceptual diagram illustrating an example of a schematic configuration of a laser cutting apparatus according to a first embodiment of the present disclosure.

FIG. 2 A cross-sectional view showing a relationship between a nozzle part and a laser irradiation position in a laser cutting apparatus of the related art.

FIG. 3 A cross-sectional view showing a relationship between a nozzle part and a laser irradiation position in the laser cutting apparatus according to the first embodiment of the present disclosure.

FIG. 4 A conceptual diagram illustrating an example of a schematic configuration of a laser cutting apparatus according to a second embodiment of the present disclosure.

FIG. 5 A photograph showing a state of a cut surface in Example 1.

FIG. 6 A photograph showing a state of a cut surface in Comparative Example 1.

### DESCRIPTION OF EMBODIMENTS

### First Embodiment

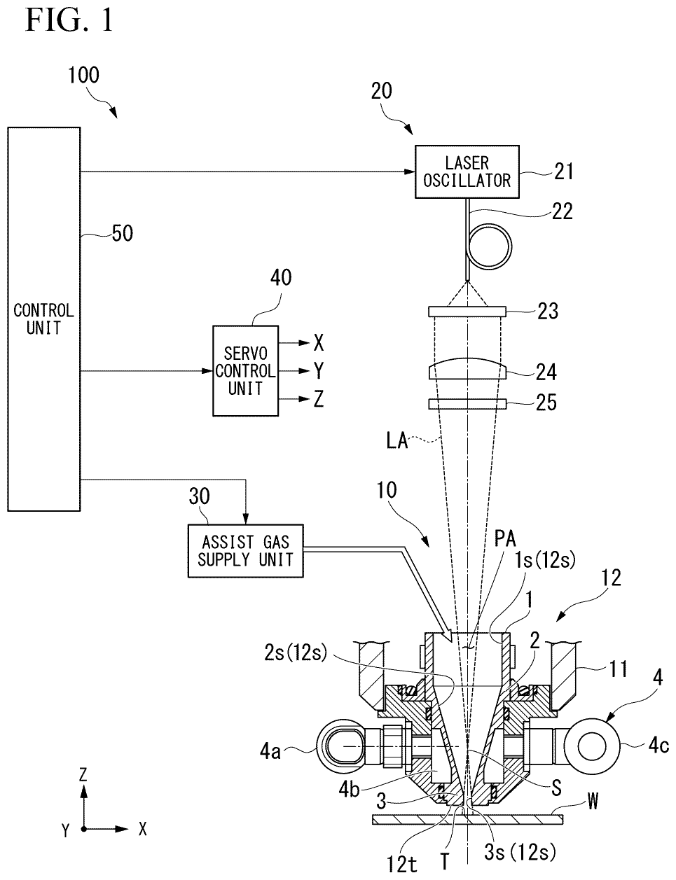

A first embodiment of the present disclosure will be described with reference to FIGS. 1 to 3.

In the present embodiment, as shown in FIG. 1, in an X axis, a Y axis, and a Z axis which are orthogonal to each other, the X axis is defined as a horizontal front-rear direction, the Y axis is defined as a horizontal left-right direction, and the Z axis is defined as a vertical up-down direction.

FIG. 1 is a conceptual diagram illustrating an example of a schematic configuration of a laser cutting apparatus 100 according to the present embodiment.

The laser cutting apparatus 100 includes a laser processing head 10, a laser irradiation device 20, an assist gas supply unit 30, a servo control unit 40, and a control unit 50.

The laser processing head 10 includes a support part 11 and a nozzle part 12. The support part 11 is a base part of the laser processing head 10, and the nozzle part 12 is removably connected thereto.

The nozzle part 12 has a substantially cylindrical shape and forms a laser passage area PA surrounded by an inner circumferential surface 12s of the nozzle part 12. The nozzle part 12 includes a straight portion 1, a tapered portion 2, a tip end portion 3, and a cooling portion 4.

The straight portion 1, the tapered portion 2, and the tip end portion 3 are formed of a material containing copper and form a base portion of the nozzle part 12. The straight portion 1, tapered portion 2, and tip end portion 3 are connected to each other in that order from an upper side on the Z axis to form a substantially cylindrical shape, and the diameter of the tapered portion 2 is reduced from the straight portion 1 toward the tip end portion 3. That is, the straight portion 1 and the tip end portion 3 having a smaller diameter than the straight portion 1 are connected to each other via the tapered portion 2.

The inner circumferential surface 12s of the nozzle part 12 is formed by an inner circumferential surface 1s of the straight portion 1, an inner circumferential surface 2s of the tapered portion 2, and an inner circumferential surface 3s of the tip end portion 3.

When performing laser cutting, a laser LA enters the laser passage area PA from an opening on an upper side of the straight portion 1 on the Z axis, is passed through the laser passage area PA, and is emitted onto a workpiece W from an opening on an lower side of the tip end portion 3 on the Z axis.

The cooling portion 4 includes a water inlet portion 4a, an annular portion 4b, and a water outlet portion 4c. The water inlet portion 4a has a substantially cylindrical shape and is connected to a cooling device (not shown). A liquid such as water flows into a hollow portion of the water inlet portion 4a from the cooling device. The annular portion 4b is a hollow, substantially circular ring body disposed to surround the tapered portion 2. The annular portion 4b is connected to the water inlet portion 4a, and the liquid flowing into the water inlet portion 4a is passed through the hollow portion of the water inlet portion 4a and flows into a hollow portion of the annular portion 4b.

The water outlet portion 4c has a substantially cylindrical shape, in which one opening thereof is connected to the annular portion 4b, and the other opening thereof is connected to the cooling device. The liquid flows from the hollow portion of the annular portion 4b into a hollow portion of the water outlet portion 4c, is passed through the hollow portion of the water outlet portion 4c, and is discharged to the cooling device.

For example, the water cooled in the cooling device flows into the cooling portion from the water inlet portion 4a, is passed through the annular portion 4b, and is discharged from the water outlet portion 4c to the cooling device. The water discharged to the cooling device is cooled in the cooling device, flows back into the cooling portion from the water inlet portion 4a, and circulates through the water inlet portion 4a, the annular portion 4b, and the water outlet portion 4c. As a result, the water cooled by the cooling device flows around and in the vicinity of the tapered portion 2, and thus the tapered portion 2 is cooled. The straight portion 1 and the tip end portion 3 are cooled by the cooling portion 4 via the tapered portion 2, and thus the entire nozzle part 12 is cooled.

The laser irradiation device 20 includes a laser oscillator 21, a laser beam irradiation unit 22, a collimating lens 23, a condensing lens 24, and a protective glass 25. The laser irradiation device 20 is, for example, a fiber laser device. One end portion of the laser beam irradiation unit 22 is connected to the laser oscillator 21, and thus the laser LA generated by the laser oscillator 21 is passed through an optical fiber included in the laser beam irradiation unit 22 and transported to the other end portion of the laser beam irradiation unit 22 to be emitted.

The collimating lens 23, the condensing lens 24, and the protective glass 25 are disposed in that order on a passage path of the laser LA emitted from the end portion of the laser beam irradiation unit 22. The collimating lens 23 corrects a traveling direction of the laser LA emitted from the end portion of the laser beam irradiation unit 22 and converts the laser into parallel collimated light. The condensing lens 24 condenses the laser corrected by the collimating lens 23. The protective glass 25 protects the condensing lens 24 from fumes, spatters, and the like that fly off from the workpiece W during laser cutting.

The assist gas supply unit 30 is connected to the laser processing head 10. The assist gas supply unit 30 supplies oxygen gas, an inert gas, or the like to the laser processing head 10. Oxygen gas, an inert gas, or the like supplied from the assist gas supply unit 30 is supplied to a processing target portion T of the workpiece W via the laser processing head 10.

The servo control unit 40 is connected to the support part 11 of the laser processing head 10. The servo control unit 40 controls the position of the laser processing head 10. For example, the laser processing head 10 can be moved in a Z-axis direction to adjust a distance between the laser processing head 10 and the workpiece W in the Z-axis direction. In addition, by adjusting the position of the laser processing head 10 in an X-axis direction or a Y-axis direction, the laser processing head 10 can be moved in a cutting direction of the workpiece W.

The control unit 50 is connected to the laser irradiation device 20, the assist gas supply unit 30, and the servo control unit 40. By transmitting a command from the control unit 50 to the laser irradiation device 20, it is possible to control the generation of the laser LA in the laser oscillator 21, the output of the generated laser LA, the position of the condensing lens 24, and the like.

In addition, by transmitting a command from the control unit 50 to the assist gas supply unit 30, it is possible to control the pressure, the flow rate, the concentration, and the like of the gas supplied from the assist gas supply unit 30 to the laser processing head 10.

Furthermore, by transmitting a command from the control unit 50 to the servo control unit 40, it is possible to control the position of the laser processing head 10, the cutting path along which the laser processing head 10 moves in order to cut the workpiece W, and the like. The control unit 50 is, for example, a program-executable device (a computer) that includes a processor, a memory, a storage unit, and the like.

Each function of the control unit 50 is realized by one or more processors, such as a central processing unit (CPU) and a graphics processing unit (GPU), executing programs stored in a program memory. However, all or some of these functions may be realized by hardware (for example, a circuity) such as a large scale integration (LSI), an application specific integrated circuit (ASIC), a field-programmable gate array (FPGA), and a programmable logic device (PLD). In addition, all or some of the above functions may be realized by a combination of software and hardware. The storage unit is realized by a flash memory, an electrically erasable programmable read only memory (EEPROM), a read only memory (ROM), a random access memory (RAM), or the like.

Next, a cutting method for cutting the workpiece W using the laser cutting apparatus 100 will be described.

The laser irradiation device 20 places the condensing lens 24 at a predetermined position in response to the command transmitted from the control unit 50. Furthermore, the laser oscillator 21 generates the laser LA in response to the command transmitted from the control unit 50 and sends it to the laser beam irradiation unit 22 connected to the laser oscillator 21. The laser beam irradiation unit 22 transports the laser LA to an end portion opposite to an end portion connected to the laser oscillator 21 and emits the laser LA to the collimating lens 23. The collimating lens 23 corrects the traveling direction of the laser LA emitted from the laser beam irradiation unit 22 into the Z-axis direction and irradiates the condensing lens 24 with the laser LA.

The condensing lens 24 corrects the traveling direction of the laser LA emitted from the collimating lens 23 and converges the laser LA to form a focal point (a spot S). The laser LA emitted from the condensing lens 24 is passed through the protective glass 25 and is emitted to the nozzle part 12.

The laser LA emitted to the nozzle part 12 enters the laser passage area PA from an opening on an upper side of the straight portion 1 on the Z axis, is passed through the laser passage area PA, and is emitted to the processing target portion T of the workpiece W from an opening on an lower side of the tip end portion 3 on the Z axis.

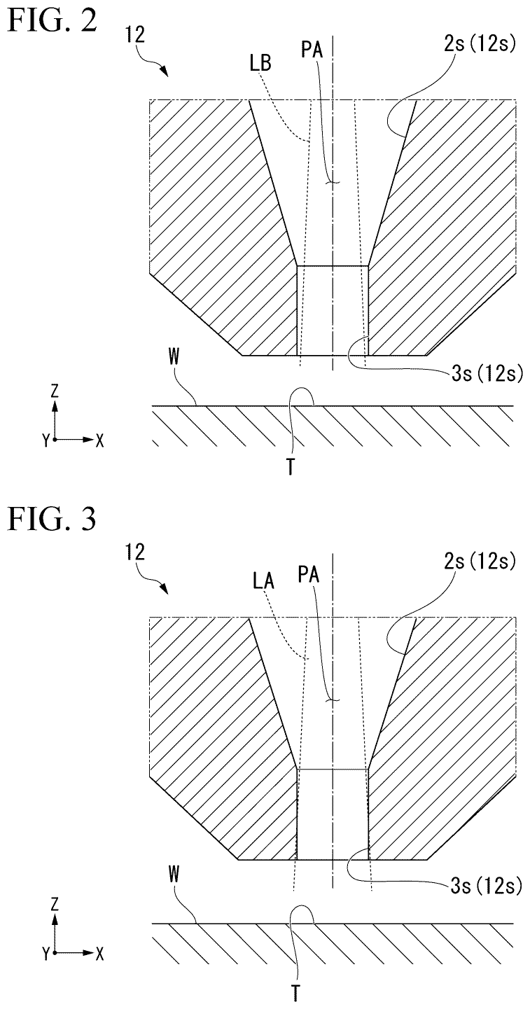

FIGS. 2 and 3 are cross-sectional views showing a relationship between the nozzle part 12 and a laser irradiation position. FIG. 2 is a cross-sectional view showing a relationship between the nozzle part 12 and the laser irradiation position in a laser cutting apparatus of the related art, and a laser LB is emitted onto the workpiece W without interfering with the inner circumferential surface 12s of the nozzle portion 12.

FIG. 3 is a cross-sectional view showing a relationship between the nozzle part 12 and the laser irradiation position in the laser cutting apparatus 100 according to the present embodiment, and the laser LA is emitted onto the workpiece W while interfering with the inner circumferential surface 3s of the tip end portion 3. In this way, the roughness of the cut surface of the workpiece W can be reduced.

As shown in FIG. 3, the control unit 50 controls the position of the condensing lens 24 such that the laser LA is emitted onto the workpiece W while interfering with the inner circumferential surface 3s of the tip end portion 3.

In this way, the laser LA emitted onto the workpiece W heats and melts the processing target portion T of the workpiece W irradiated with the laser LA.

In response to the command transmitted from the control unit 50, the assist gas supply unit 30 supplies oxygen gas, an inert gas, or the like having a predetermined pressure, a predetermined flow rate, and a predetermined concentration to the processing target portion T of the workpiece W via the laser processing head 10. The supplied assist gas such as oxygen gas or an inert gas blows away the molten portion of the workpiece W.

The servo control unit 40 moves the laser processing head 10 in the cutting direction in response to the command transmitted from the control unit 50. In this way, the laser LA is emitted onto the workpiece W, and the laser processing head 10 is moved in the cutting direction while a portion of the workpiece W melted with the laser LA is blown away with the assist gas, and thus the workpiece W is cut.

In the laser cutting method of the laser cutting apparatus 100, the laser LA is emitted onto the workpiece W while interfering with the inner circumferential surface 3s of the tip end portion 3. For this reason, there is a risk that the temperature of the tip end portion 3 will increase due to the laser LA, causing it to melt.

The cooling portion 4 is connected to a cooling device, and the liquid flowing in from the cooling device is circulated inside the cooling portion 4, and thus the nozzle part 12 is cooled. As a result, the temperature rise of the tip end portion 3 due to interference with the laser LA is suppressed, and melting of the tip end portion 3 is suppressed.

In addition, the laser cutting apparatus 100 detects a cutting height using a height sensor (a capacitance type sensor) (not shown) connected to the nozzle part 12. If the temperature of the nozzle part 12, which has increased due to interference between the laser LA and the inner circumferential surface 3s of the tip end portion 3, is transmitted to the height sensor, the height sensor may malfunction, causing the cutting height to become unstable.

The nozzle part 12 is cooled by the cooling portion 4 to prevent malfunction of the height sensor.

According to the laser cutting apparatus 100 of the present embodiment, the laser LA is emitted onto the workpiece W while interfering with the inner circumferential surface 3s of the tip end portion 3, and thus the roughness of the cut surface of the workpiece W can be reduced. In addition, since the nozzle part 12 is equipped with the cooling portion 4 and the liquid flows into the cooling portion 4 to cool the nozzle part 12, it is possible to prevent the temperature of the tip end portion 3 from increasing due to interference with the laser LA and to prevent the tip end portion 3 from melting. Furthermore, the cooling portion 4 cools the nozzle part 12, thereby preventing malfunction of the height sensor and enabling stable cutting.

As a result, it is possible to provide the laser cutting apparatus 100 and the laser cutting method by which the roughness of the cut surface of the workpiece W is reduced.

### Second Embodiment

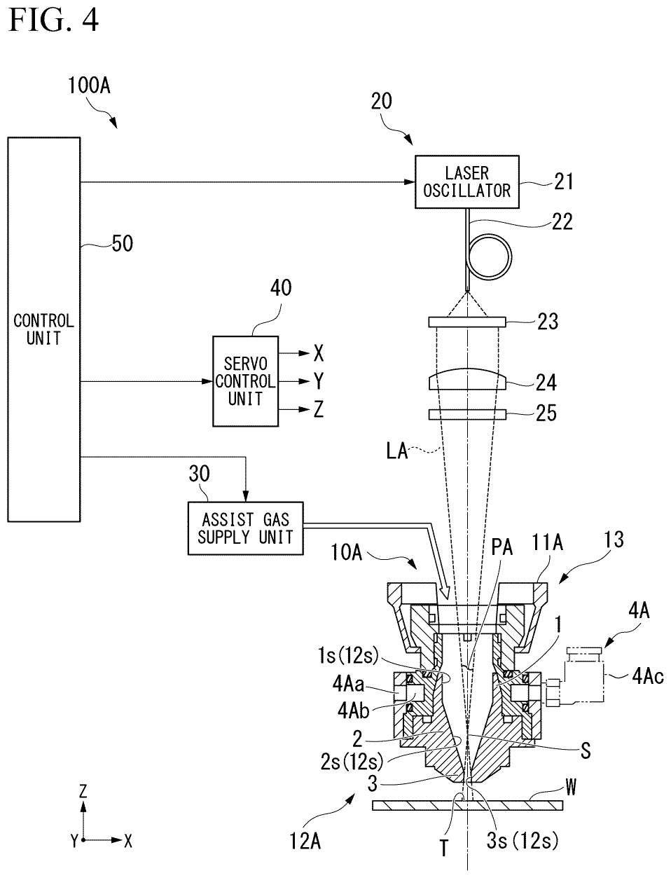

A second embodiment of the present disclosure will be described with reference to FIG. 4. In the following description, the same constituent elements as those already described are designated by the same reference signs, and duplicate description will be omitted.

FIG. 4 is a conceptual diagram illustrating an example of a schematic configuration of a laser cutting apparatus 100A according to the present embodiment.

A laser processing head 10A includes a support part 11A, a nozzle part 12A, and a cooling adapter 13. The nozzle part 12A includes a straight portion 1, a tapered portion 2, and a tip end portion 3. That is, the nozzle part 12A does not include the cooling portion 4 that is included in the nozzle part 12 of the first embodiment.

The nozzle part 12A and the cooling adapter 13 are connected to the support portion 11A and are each removable therefrom. The cooling adapter 13 has a cooling portion 4A. The cooling portion 4A includes a water inlet portion 4Aa, an annular portion 4Ab, and a water outlet portion 4Ac.

The water inlet portion 4Aa has a substantially cylindrical shape and is connected to a cooling device (not shown). A liquid such as water flows into a hollow portion of the water inlet portion 4Aa from the cooling device. The annular portion 4Ab is a hollow, substantially circular ring body that surrounds the straight portion 1 and is disposed in the cooling adapter 13. The annular portion 4Ab is connected to the water inlet portion 4Aa, and the liquid flowing into the water inlet portion 4Aa is passed through the hollow portion of the water inlet portion 4Aa and flows into a hollow portion of the annular portion 4Ab.

The water outlet portion 4Ac has a substantially cylindrical shape, in which one opening thereof is connected to the annular portion 4Ab, and the other opening thereof is connected to the cooling device. The liquid flows from the hollow portion of the annular portion 4Ab into a hollow portion of the water outlet portion 4Ac, is passed through the hollow portion of the water outlet portion 4Ac, and is discharged to the cooling device.

For example, the water cooled in the cooling device flows into the cooling portion from the water inlet portion 4Aa, is passed through the annular portion 4Ab, and is discharged from the water outlet portion 4Ac to the cooling device. The water discharged to the cooling device is cooled in the cooling device, flows back into the cooling portion from the water inlet portion 4Aa, and circulates through the water inlet portion 4Aa, the annular portion 4Ab, and the water outlet portion 4Ac. As a result, the water cooled by the cooling device flows around and in the vicinity of the straight portion 1, and thus the straight portion 1 is cooled via the cooling adapter 13. The tapered portion 2 and the tip end portion 3 connected to the straight portion 1 are cooled by the cooling portion 4A of the cooling adapter 13, and thus the entire nozzle part 12A is cooled.

In addition, since the nozzle part 12A and the cooling adapter 13 are each connected to the support part 11A, it is possible to remove only the nozzle part 12A from the support part 11A while the cooling adapter 13 is still connected to the support part 11A.

According to the laser cutting apparatus 100A of the present embodiment, the laser LA is emitted onto the workpiece W while interfering with the inner circumferential surface 3s of the tip end portion 3, and thus the roughness of the cut surface of the workpiece W can be reduced. In addition, since the laser processing head 10A is equipped with the cooling adapter 13 and the liquid flows into the cooling portion 4A of the cooling adapter 13 to cool the nozzle part 12A, it is possible to prevent the temperature of the tip end portion 3 from increasing due to interference with the laser LA and to prevent the tip end portion 3 from melting. Furthermore, the cooling adapter 13 cools the nozzle part 12A, thereby preventing malfunction of the height sensor and enabling stable cutting.

As a result, it is possible to provide the laser cutting apparatus 100A and the laser cutting method by which the roughness of the cut surface of the workpiece W is reduced.

Furthermore, since the nozzle part 12A and the cooling adapter 13 are each removably connected to the support part 11A, it is possible to remove only the nozzle part 12A from the support part 11A without removing the cooling adapter 13 from the support part 11A.

As a result, when the nozzle part 12A is removed from the support part 11A, it is possible to remove the nozzle part 12A without the liquid leaking to the outside from a connection portion between the cooling adapter 13 and the cooling device, or the like.

In the above, the embodiments of the present invention have been described in detail with reference to the drawings, but the specific configuration is not limited to the above-described embodiments, and a design change and the like within a range not departing from the gist of the present invention are also included. In addition, the constituent elements shown in the above-described embodiments and a modification example shown below can be appropriately combined and configured.

### Modification Example 1

In the first embodiment, the annular portion 4b is disposed in the vicinity of the tapered portion 2, but the aspect of the annular portion is not limited to this. The annular portion may be disposed, for example, in the vicinity of the straight portion 1 or the tip end portion 3 as long as it can cool the inner circumferential surface 3s of the tip end portion 3 that interferes with the laser LA.

### Modification Example 2

In the second embodiment, the annular portion 4Ab is disposed in the vicinity of the straight portion 1, but the aspect of the annular portion is not limited to this. The annular portion may be disposed, for example, in the vicinity of the tapered portion 2 or the tip end portion 3 as long as it can cool the inner circumferential surface 3s of the tip end portion 3 that interferes with the laser LA.

### Modification Example 3

In each of the above-described embodiments, the water outlet portion 4c (4Ac) is connected to the cooling device, but the aspect of the water outlet portion is not limited to this. The water outlet portion may be configured to discharge the flowing-in liquid to the outside such as a drainage channel or the like without being connected to the cooling device. In a case in which the water outlet portion is not connected to the cooling device, for example, the nozzle part 12 (12A) is cooled by continuously flowing a new liquid into the cooling portion without circulating the liquid between the cooling portion and the cooling device.

### Modification Example 4

In each of the above-described embodiments, the laser cutting apparatus 100 (100A) includes the cooling portion 4 (4A), but the aspect of the laser cutting apparatus is not limited to this. The laser cutting apparatus may not include the cooling portion 4 (4A). Even if the nozzle part 12 is not cooled by the cooling portion 4 (4A), stable cutting can be performed if the cutting processing is performed for a short period of time.

### Modification Example 5

In each of the above-described embodiments, the laser LA is emitted onto the workpiece W while interfering with the inner circumferential surface 3s of the tip end portion 3, but the aspect of the laser is not limited to this. The laser may be emitted onto the workpiece W while interfering with the inner circumferential surface 12s of the nozzle part 12, such as, the inner circumferential surface 1s of the straight portion 1 or the inner circumferential surface 2s of the tapered portion 2 other than the inner circumferential surface 3s of the tip end portion 3.

### Modification Example 6

In each of the above-described embodiments, the control unit 50 causes the laser LA to interfere with the nozzle part 12 (12A) by controlling the position of the condensing lens 24, but the aspect of the control unit is not limited to this. The control unit may, for example, cause the laser LA to interfere with the nozzle part by switching a plurality of condensing lenses, or may cause the laser to interfere with the nozzle part by controlling the position or angle of the nozzle part and the like.

The present invention will be described in detail below with reference to examples. The present invention is not limited to the following examples.

### Example 1

A steel material was laser cut using the laser cutting apparatus 100 under the following conditions. In addition, a distance in the Z-axis direction from a tip end 12t of the nozzle part 12 to a spot S, which are shown in FIG. 1, was 17.5 mm, and the laser LA was emitted onto the steel material while interfering with the inner circumferential surface 3s of the tip end portion 3 as shown in FIG. 3.
Output: 12000 W, Duty: 100%
Assist gas pressure: 0.12 MPa
Cutting speed: 1200 mm/min, cutting height: 0.5 mm

### Comparative Example 1

The steel material was laser cut in the same manner as in Example 1, except that the distance in the Z-axis direction from the tip end of the nozzle part to the spot was 13.5 mm, and the laser was emitted onto the steel material without interfering with the nozzle part as shown in FIG. 2.

### Experiment 1

In the cut surfaces of Example 1 and Comparative Example 1, the ten-point average roughness Rzjis was measured at the following three portions.
Measurement portion (a): a position at 3 mm from the surface of the steel material on a side irradiated with the laser in the Z-axis direction
Measurement portion (b): a position at half the thickness of the steel material in the Z-axis direction
Measurement portion (c): a position at 3 mm from the surface of the steel material on a side opposite to the side irradiated with the laser in the Z-axis direction

### Experiment 2

In the cut surfaces of Example 1 and Comparative Example 1, the maximum heights Rz were measured at the measurement portions (a) to (c) in Experiment 1.

### Experiment Results

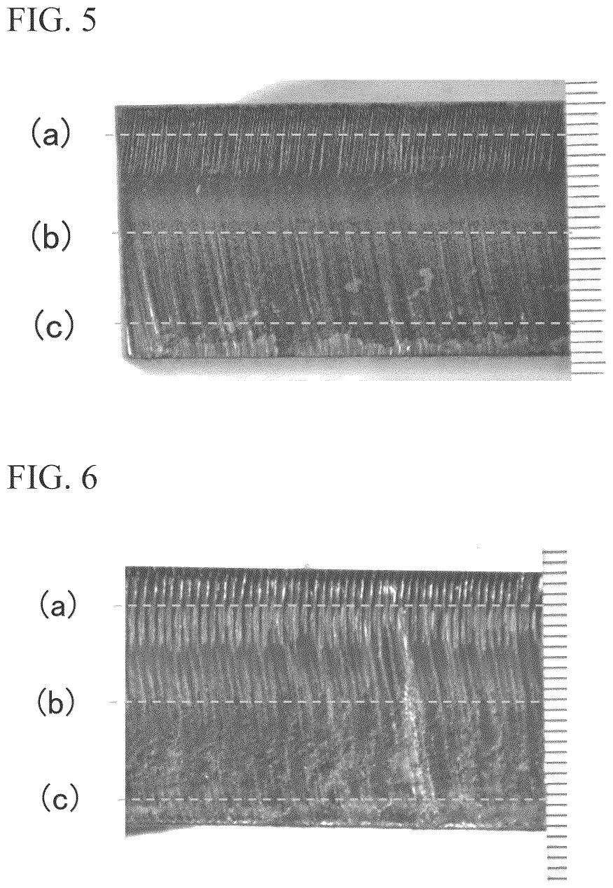

FIG. 5 is a photograph showing the cut surface in Example 1. In addition, FIG. 6 is a photograph showing the cut surface in Comparative Example 1. (a), (b) and (c) of FIG. 5 and FIG. 6 show the measurement portions (a) to (c). The results of Experiment 1 are shown in Table 1. In all the three measurement portions, the ten-point average roughness Rzjis of the cut surface of Example 1 was smaller than the ten-point average roughness Rzjis of the cut surface of Comparative Example 1.

The results of Experiment 2 are shown in Table 2. In all the three measurement portions, the maximum height Rz of the cut surface of Example 1 was smaller than the maximum height Rz of the cut surface of Comparative Example 1.

TABLE 1

| | Rzjis (μm) | | |
|---|---|---|---|
| | (a) | (b) | (c) |
| Example 1 | 13 | 9 | 17 |
| Comparative Example 1 | 117 | 18 | 19 |

TABLE 2

| | Rz (μm) | | |
|---|---|---|---|
| | (a) | (b) | (c) |
| Example 1 | 18 | 17 | 34 |
| Comparative Example 1 | 169 | 31 | 37 |

### REFERENCE SIGNS LIST

100 Laser cutting apparatus
10 Laser processing head
11 Support part
12 Nozzle part
12s Inner circumferential surface of nozzle part
1 Straight portion
1s Inner circumferential surface of straight portion
2 Tapered portion
2s Inner circumferential surface of tapered portion
3 Tip end portion
3s Inner circumferential surface of tip end portion
4 Cooling portion
20 Laser irradiation device
21 Laser oscillator
22 Laser beam irradiation unit
23 Collimating lens
24 Condensing lens
30 Assist gas supply unit
40 Servo control unit
50 Control unit
LA Laser
PA Laser passage area
W Workpiece
T Processing target portion

1. A laser cutting apparatus for laser cutting a workpiece comprising:
a laser irradiation device having a laser beam irradiation unit for emitting a laser;
a laser processing head disposed at a side of the workpiece of the laser beam irradiation unit; and
a control unit,
wherein the laser processing head has a nozzle part at a tip end on a side of the workpiece, and
wherein the control unit performs control on at least one of the laser irradiation device and the laser processing head such that the laser is emitted onto the workpiece while interfering with an inner circumferential surface of the nozzle part.

2. The laser cutting apparatus according to claim 1,
wherein the laser irradiation device includes a condensing lens, and
wherein the control unit controls a position of the condensing lens such that the laser is emitted onto the workpiece while interfering with the inner circumferential surface of the nozzle part.

3. The laser cutting apparatus according to claim 1, wherein the control unit controls a position of the nozzle part such that the laser is emitted onto the workpiece while interfering with the inner circumferential surface of the nozzle part.

4. The laser cutting apparatus according to claim 1, wherein the nozzle part includes a cooling portion that causes a liquid to flow into the nozzle part.

5. The laser cutting apparatus according to claim 1,
wherein the laser processing head has a cooling adapter, and
wherein the cooling adapter includes a cooling portion that causes a liquid to flow into the vicinity of the nozzle part.

6. A laser cutting method for laser cutting a workpiece comprising emitting a laser onto the workpiece while causing the laser to interfere with an inner circumferential surface of a nozzle part.

7. The laser cutting method according to claim 6, further comprising introducing a liquid into a cooling portion to cool the nozzle part.
